(19) United States
(12) Patent Application Publication
(10) Pub. No.: US 2026/0137109 A1
(43) Pub. Date: May 21, 2026

(54) Method for Infusing Flavors Into Shrimp, Seafoods, and Other Consumable Proteins

(71) Applicant: Afritex Ventures, Inc., Plano, TX (US)

(72) Inventors: Jason Ferraro, Dallas, TX (US); Gavin van der Burgh, Longwood, FL (US)

(73) Assignee: Afritex Ventures, Inc., Plano, TX (US)

(21) Appl. No.: 19/118,967

(22) PCT Filed: Oct. 7, 2022
(86) PCT No.: PCT/US2022/077745

§ 371 Date: Apr. 7, 2025

(51) Int. Cl. A23L 17/40; A23B 2/10; A23B 2/725; A23B 2/82; A23B 4/07; A23B 4/18

(52) U.S. Cl. CPC A23L 17/40; A23B 2/103; A23B 2/725; A23B 2/82; A23B 4/07; A23B 4/18

(57) ABSTRACT

The improved process for infusion of flavors into delicate shrimp and other seafood and consumable protein products involves utilization of a tumbler device with a drum inner chamber having screw-type baffles, each baffle having a product facing surface forming an acute angle with respect to the inner chamber surface. The tumbler drum variable in rotational speed and capable of maintaining a preset vacuum pressure within the chamber. Raw product is tumbled within the chamber under a predetermined pressure for a predetermined period at a predetermined rotational speed to infuse the flavor-profile brine within the seafood product.

### TECHNICAL FIELD

The present invention relates to processing of proteins for human consumption and, more specifically, to the processing of shrimp, seafoods, and other consumable proteins to infuse flavors therein for improvement of taste and enjoyment.

### BACKGROUND OF THE INVENTION

Consumption of seafood has continued to rise as consumers look for more healthful and flavorful food options. However, individual preparation of seafood meals tends to be time consuming and is seen as requiring preparation expertise that most are unwilling to develop. Consequently, busy consumers look to pre-prepared seafood meals to save time and effort, increasing the market demand for such commercially prepared meals.

Proteins for consumption are often prepared on a commercial scale using a conventional food tumbler device. The purpose of a tumbler device is to accept a food product within the chamber of a drum capable of rotation, wherein baffles within the drum chamber attached to the chamber walls periodically contact the food product as the drum rotates, thereby impacting the food product and causing flipping and mixing thereof. A brine is often added to the chamber as well, to further tenderize and flavor the product as it is impacted and flipped. Unfortunately, this traditional process unduly stresses the tumbled food product causing breakage and reduced yield of commercially acceptable product, and is wholly unfit for delicate consumable proteins including shrimp, scallops, fish fillets and pieces, and the like.

Traditionally processed seafood tends to have little to no flavor, requiring substantial additional preparation time and effort to create a truly palatable meal. With regard to shrimp, the current industry practice is to either coat the shrimp on the outside with a breading and/or flavoring substance, or to simply place the shrimp into an external sauce for flavoring. However, such coatings and sauces dramatically alter the natural appearance of the shrimp making it visually unappealing to a consumer. Moreover, the coatings and sauces tend to separate from the shrimp thereby negatively affecting the taste enjoyment given that all of the flavor resides on the surface of the shrimp and not on the inside. This applies to all such delicate seafoods.

Therefore, a need exists for a process for infusing highly-palatable flavors into seafood that protects the delicate nature of the seafood and maintains its enhanced taste and visual appeal. The present invention satisfies this need and others as will become apparent upon reading and comprehending the details disclosed herein.

### BRIEF SUMMARY OF THE INVENTION

This process solves for the need to take a ready to eat shrimp and have to dip it into a sauce (such as cocktail sauce) in order to derive an added flavor. The Infusion process allows for the transfer of a wide range of flavors into the shrimp itself without the need to coat the product or have an external sauce. The flavor emanates from within the product, not from without. This process also preserves the natural seafood color and precludes the need to add flavors to subsequent breading or other value-additive coatings or sauces.

The process involves use of a screw type vacuum tumbler having baffles, each forming an acute angle with respect to the tumbler drum inner chamber wall. The drum is capable of rotation at variable speeds from 1 RPM to 1000 RPM, but a maximum of 50 RPM is preferred. The drum chamber is capable of maintaining a vacuum during the process of between about 1 inch of mercury to about 28 inches of mercury, depending on the seafood. A flavor-profile brine ingredient is added to the product within the drum chamber. The brine depends on the type of flavor desired, and varies from 10% solution to 20% depending on the intensity of flavor being targeted. The combination of the vacuum pressure, rotation speed, rotation time, and the brine ingredients results in flavor infusing into the shrimp and other seafood products without changing the color of the natural protein. For example, the shrimp cocktail brined shrimp, tastes like it has been dipped into the traditional cocktail sauce of a red tomato and horseradish but the shrimp still retains its natural color.

A novel and inventive method for achieving this is provided as set out in claim 1. Optional features are set out in the dependent claims.

The novel features that are considered as characteristic for the invention are set forth particularly in the appended claims. The invention itself, however, both as to its construction and methods of operation, together with additional objects and advantages thereof, will be best understood from the following description of specific embodiments when read with the accompanying drawings.

### BRIEF DESCRIPTION OF THE SEVERAL VIEWS OF THE DRAWING(S)

The present invention may be more fully understood by reference to the following detailed description of the preferred embodiments of the invention when read in conjunction with the accompanying drawings, wherein:

FIG. 1 presents a system-level diagram of the device stations utilized in a preferred embodiment of the invention, where raw protein product enters at the left of the first stage (FIG. 1A) and exits as processed product at the right of the second stage (FIG. 1B);

FIG. 2 presents a side view of the tumbler device utilized in the embodiment, highlighting its angular orientation with respect to the surface upon which it is mounted;

FIG. 3 presents a ghosted view of the drum of the tumbler device, emphasizing the screw-type baffle arrangement important to the thorough and delicate processing of the protein product;

FIG. 4 presents a closeup view of the tumbler device baffle arrangement as visible through the tumbler product entry door opening;

FIG. 5 presents a cross-sectional depiction of a segment of the tumbler device drum in the area of a baffle, emphasizing the baffle face and the acute angle formed with respect to the tumbler device chamber inner surface;

FIG. 6 presents a flow diagram of the basic processing method steps; and

FIG. 7 presents a flow diagram of additional detailed process method steps regarding the tumbler device utilization in the process.

The above figures are provided for illustration and description only, and are not intended to limit the disclosed invention. Use of the same reference number in multiple figures is intended to designate the same or similar parts. Furthermore, if, and when, the terms “top,” “bottom,” “first,” “second,” “upper,” “lower,” “height,” “width,” “length,” “end,” “side,” “horizontal,” “vertical,” and similar terms are used herein, these terms are intended to reference only the structure shown in the drawing to facilitate describing the specific embodiment. The extension of the figures with respect to number, position, relationship, and dimensions of the parts to form the preferred embodiment will be explained or will be within the skill of the art after the following teachings of the present invention have been thoughtfully considered.

### DETAILED DESCRIPTION OF THE EMBODIMENTS

The present invention involves use of contemporary industrial food processing equipment the utilization and operation of which will be readily appreciated by one of ordinary skill in the art to which the invention applies. Specialty equipment, where indicated, will be appreciated in light of the following detailed discussion.

The consumable protein processing method invention discussed herein is directed primarily to the processing of delicate raw shrimp and other seafoods, for example, scallops, fish portions, fish fillets, and the like, but may be extended to other consumable proteins. Accordingly, use herein of the terms shrimp, scallops, fish portions, fish fillets, consumable proteins, consumable protein products, or simply products refers to same. Product may be raw at the outset (raw product) and is subsequently processed (processed product).

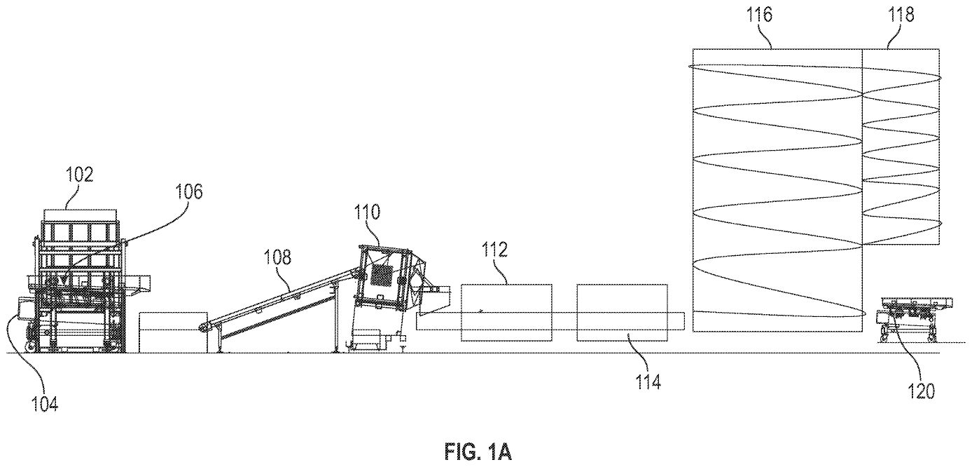

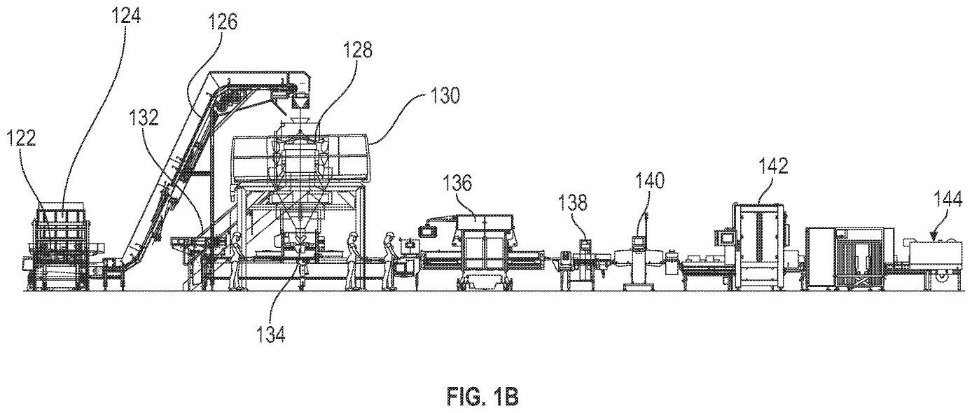

FIG. 1 presents a system-level diagram of the device stations utilized in a preferred embodiment of the invention, wherein raw protein product enters at the left of the first stage (FIG. 1A) and exits as processed product at the right of the second stage (FIG. 1B). This embodiment includes optional stations determined solely by the subsequent processing steps desired. Accordingly, certain stations may or may not be present in additional embodiments.

Because the products are initially substantially frozen and quite weighty in bulk, it is helpful to utilize a means for lifting, separating, and pouring the product individual pieces onto a conveyor for controlled transport. The first station (102) presents a conventional gaylord lift or tilter device capable of safely lifting and pouring the container of product. The gaylord (102) pours the initial unprocessed raw product onto a vibratory feeder (104) having a wire-mesh or perforated screen (106) supporting the poured product. The vibratory feeder (104) separates the product through vibratory energy while debris and undesirable elements pass through the screen (106) as the product is directed to a conveyor device (108) for conveyance of the product to the next station.

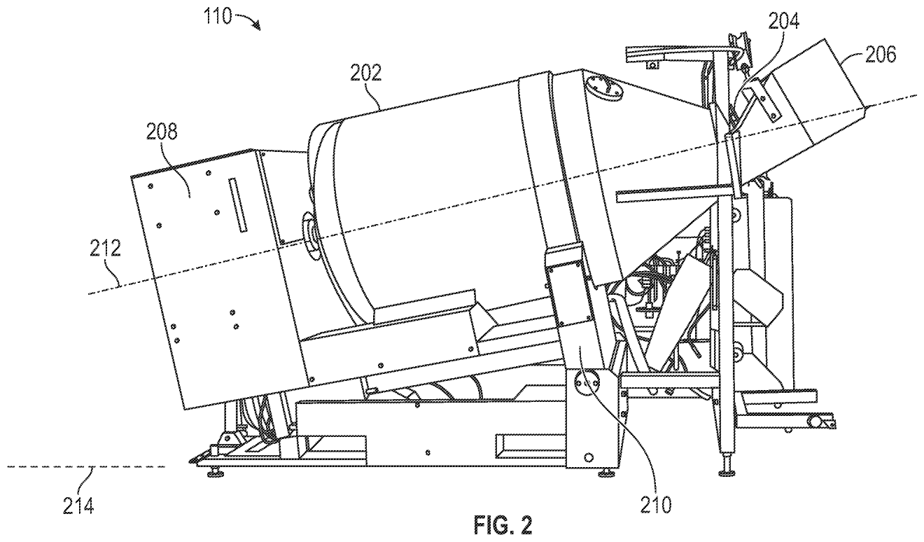

The next station comprises a specialized tumbler (110) device for effecting the novel and inventive process method herein. FIGS. 2 through 5 present the necessary tumbler elements in additional detail.

FIG. 2 presents a side view of the tumbler (110) device utilized in the embodiment, highlighting its angular orientation with respect to the surface upon which it is mounted. The tumbler (110) includes a drum (202) having an internal chamber with an sealable hatch (204) over an opening for receiving a product directed through a feed chute (206). An electric motor device control assembly (208) provides rotational motive force to the drum (202), allowing the drum (202) to rotate upon an axis (212). Forward supports (210) allow for the adjustable tilt of the drum (202) such that an acute angle may be established between the axis of rotation (212) and the surface upon which the tumbler (110) is supported (214), between approximately 0 degrees and approximately 45 degrees. In another embodiment this tilt is not adjustable during operation but is fixed at a desired angle. The acute angle has the effect of pooling the product/brine near the lower portion of the drum (202) as the product/brine seeks to level with the surface (214) during tumbling operation. Unique baffles within the drum (202) operate to manipulate the product to assist in the processing.

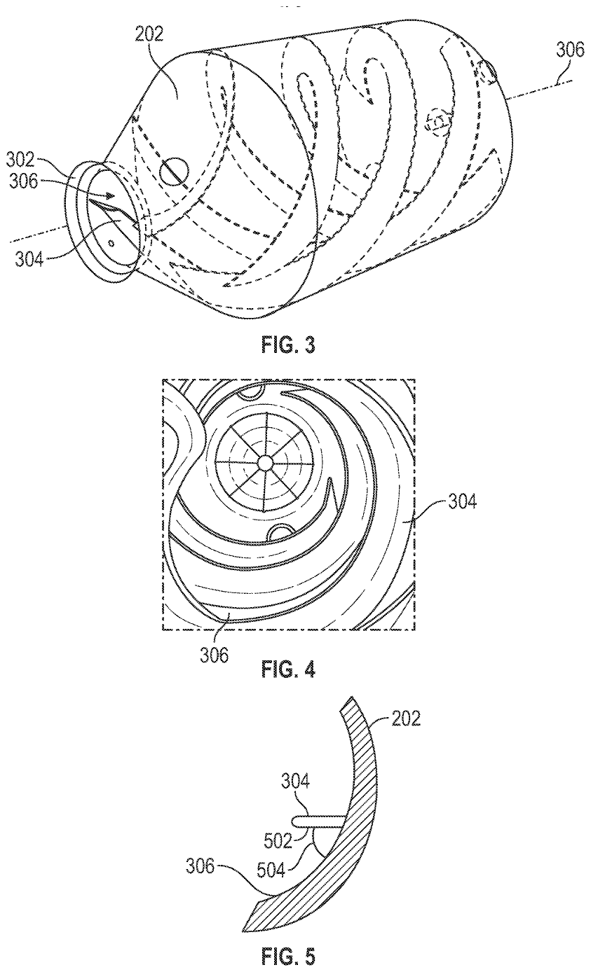

FIG. 3 presents a ghosted view of the drum (202) of the tumbler device, emphasizing the screw-type baffle arrangement important to the processing of the delicate protein products. With the sealable hatch (204) removed, the plurality of baffles (304) are visible within the inner chamber. The baffles (304) contact the chamber inner wall (306) and spiral around the drum inside wall (306) surface from the opening (302) to the rearward wall as depicted. FIG. 4 presents a more direct, closeup view of the tumbler device baffle (304) arrangement as visible through the tumbler product entry door opening (302). From this view it can be more readily seen that the baffles (304) attach to the drum chamber inner wall (306). FIG. 5 presents a cross-sectional depiction of a segment of the tumbler device drum (202) in the area of a baffle, emphasizing the baffle (304) face (502) and the acute angle (504) formed with respect to the tumbler device chamber inner surface (306). As shown, the baffle (304) has a product facing surface (502) that is in contact with the product/brine as the drum (202) rotates during operation. An acute angle (504) is formed between the product facing surface (502) and the chamber inner surface (306). The acute angle (504) is important in that it enhances the pooling of the product within the brine, maintaining maximum immersion and preventing the product from tumbling over the baffle (304), thereby preventing or dramatically reducing breakage, improving brine absorption, and increasing processed product yield.

The tumbler device (110) drum (202) is also adapted to allow a vacuum pressure to be established within the chamber before and during operation. Upon closing the sealable hatch (204), a vacuum pressure can be created within the drum chamber by evacuating the chamber with a vacuum pump. Typical vacuum pressures capable of being achieved in this embodiment range from approximately 29 inches of mercury (complete vacuum) to approximately 0 inches of mercury (no vacuum).

The tumbler device (110) controller (208) is capable of rotating the drum (202) at a revolutions per minute speed of between approximately 1 RPM and 100 RPM. This speed may be held constant during operation or may be variable, allowing product within the drum (202) chamber to be rotated at an initial speed that is changed during processing. In other embodiments the controller (208) is programmable such that rotation may be periodically paused during processing.

During tumbling operations the product within the drum chamber tends to heat due to friction and other external factors. To maintain product temperature below 9° C. (HACCP compliance), the tumbler device (110) drum (202) includes a chilling jacket through which coolant may circulate, cooling the chamber and contents below this compliance maximum temperature. This chamber temperature may be further adjusted by the programmable controller (208) to maintain a desired internal temperature for processing.

Referring once again to FIG. 1, The next station comprises a flash high pressure steamer (112). This conventional flash high pressure steamer (112) allows the processed product to be quickly cooked to a desired internal temperature to make the processed product safe for consumption. In another embodiment this station is not present and the product remains in a raw, processed state for cooking prior to consumption at a later date.

The next station comprises a thermo-shock ice chiller (114). This conventional thermo-shock ice chiller quickly cools the processed product to a near freezing temperature. This stage may be required, for example, if the previous stage cooked the processed product. However, this stage may also be omitted if raw processed product is desired.

The next station comprises a spiral freezer (116) with a spiral chute (118). The conventional spiral freezer (116) transports the processed product along a conveyor as it is completely frozen in hygienic conditions for subsequent packaging. Although a spiral freezer is depicted, this stage may comprise any commercial freezing technology, for example but not limitation, nitrogen tunnel and freon/ammonia freezing technologies, whether mechanical, cryogenic, or impingement freezing technologies or the like.

The next station comprises another vibratory feeder (120) feeding an additional gaylord lift/tilt device (124) that pours the product onto an elevator (126) device. Given that the processed product is completely frozen at this stage the vibratory feeder (122) helps to separate the pieces that may have frozen together during the previous stage. A mesh screen (122) allows ice crystals and debris to fall away as the frozen product is conveyed.

Product packaging occurs next. The next station comprises a multihead product weighing device (128). A conventional product packaging tray denester (132) separates product trays onto a conveyer beneath the multihead platform (130). The conventional multihead weighs the product and a following head (134) places the weighed product into a package. A conventional tray sealer (136) then seals the package containing the frozen product, which is then weighed (138) and scanned (140) to ensure product consistency and purity. Finished packages are then stacked (142) and packed (144) for shipping.

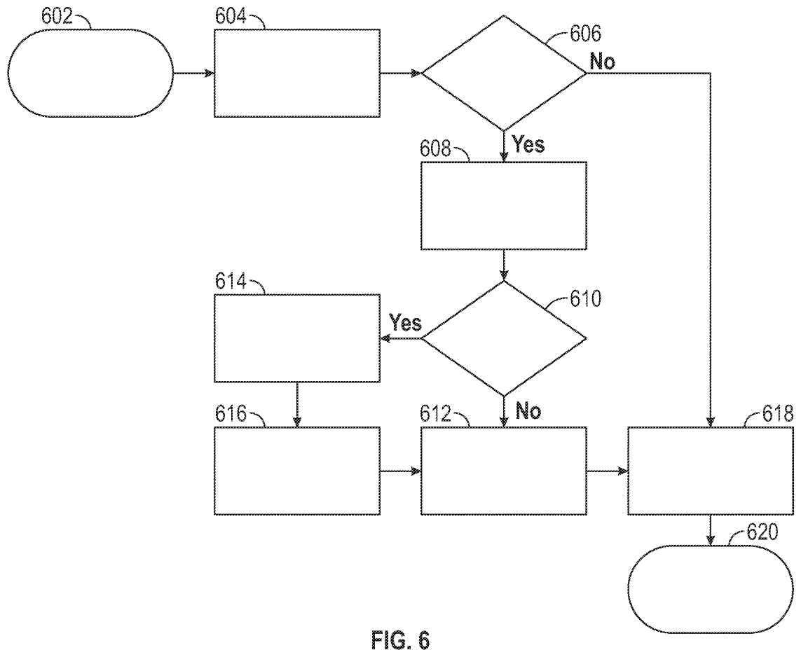

FIG. 6 presents a flow diagram of the basic processing method steps in a first embodiment utilizing the equipment described above. To begin (602), natural shrimp or other delicate seafood product pieces are separated for processing. This step may involve distributing the raw product on a vibratory conveyor, or may first involve tempering the raw product to improve subsequent processing outcome. Tempering involves the semi-defrosting of the product pieces, which can be of benefit as it reduces subsequent processing time by reducing the tumbling time required for a flavor-profile brine to enter the product pores. With regard to shrimp, it has been shown that tempering the product reduces the tumbling time by over half. In addition, tempering the product reduces the amount of external glazing present at the outset, which if not reduced can dilute the flavor-profile brine thereby negatively affecting taste of the final product. The product pieces and a flavor-profile brine are added to the chamber of a tumbler device.

The next step (604) involves the tumbling of the product and brine for a tumble period for full infusion of the flavor-profile within the product. Details of this entirely novel and inventive step of the process are presented in additional detail below.

Once the flavor profile is infused within the product, additional processing may be performed to make the product ready for commercial use. As this is a raw product, cooking may be necessary prior to consumption (606). If the product is to be made ready to eat (608), flash high-pressure seam may be utilized to very quickly cook the product to the desired safe internal temperature. If the product is not to be pre-cooked, then it is quickly frozen (618) and packaged for transport and sale (620).

Following cooking (608), additional processing is possible, for example, a breading or other value-additive coating may be desirable (610). Application of breading or additional coating (614) may occur and require additional cooking (616) to affix. The product is then quickly chilled (612) and subsequently frozen (618) and packaged for transport and sale (620). Again, these processing steps may be optional or may be performed in a different order depending upon the desired final product parameters.

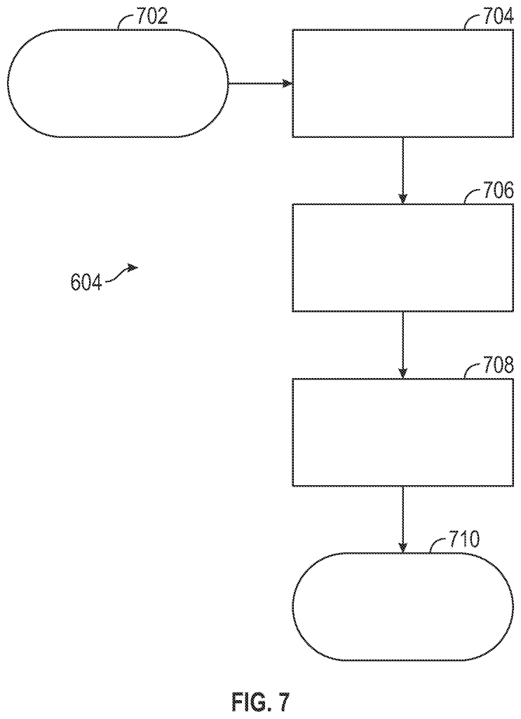

FIG. 7 presents a flow diagram of additional detailed process method steps regarding the tumbler device utilization in the novel and inventive tumbling process (604). Once the screw-type baffle tumbler device (110) chamber is filled with product (702), a specific flavor-profile brine is added to the chamber (704) for deep infusion within the product. Examples of flavor-profile brines include: Citrus Rosemary, BBQ, Salsa Roja, Lemon & Madagascar Pepper, Traditional Shrimp Cocktail, Maple Bourbon, and the like, with a percentage of sodium and/or phosphate. One of ordinary skill in the art to which the invention applies will appreciate that the desired flavor-profile may vary depending on ultimate use of the processed product.

Once the raw product and flavor-profile brine are added to the tumbler drum (202), the tumbler drum chamber is sealed (204) and a vacuum pressure is established within the chamber (706). Vacuum pressure between about 10 inches of mercury and 29 inches of mercury is preferable, depending on the protein product. Different types of protein and flavor-profile brine percentage may result in a more optimal vacuum pressure range, but seafood in general falls within this range. With regard to shrimp product, an optimal range for vacuum pressure is between approximately 20 inches of mercury to approximately 25 inches of mercury. The exact vacuum pressure to be established and held during product tumbling may be adjusted following testing of a batch to determine if the desired flavor has been achieved.

The establishment of a vacuum pressure is important in that it opens the product pores thereby allowing the flavor-profile brine to freely enter due to mechanical and osmotic action. The moisture content of raw shrimp product, for example, is between approximately 78% and approximately 84%, naturally. This process withdraws water from the shrimp, replacing same with the flavor-profile brine deep within the product tissue and, thus, maintaining the processed shrimp product at the natural (approximate) 78% to 84% moisture.

It is preferable that the tumbler (110) screw-type baffles (304) utilized in the process form an acute angle (504) between the baffle product face (502) and chamber wall (306) of between about 15 degrees and about 30 degrees. This range has shown to achieve effective pooling of the product and brine during drum (202) rotation, and to reduce product breakage resulting from a lesser or greater angle. Additionally, it is preferable that the tumbler drum (202) axis of rotation (212) be at an acute angle of less than about 30 degrees with respect to level (214). While this angle can be greater, pooling is negatively affected and greater product breakages have been shown to occur.

Next (708), the sealed drum (202) is rotated to manipulate the product/brine combination to enhance the infusion. The drum (202) rotation begins at a first speed (revolutions per minute, or RPM), and is increased over the tumble period to a second speed as the product firms. Firming of the tumbled product occurs over time as the brine enters the product. In general, it is preferable for seafood products that the first speed be about 1 RPM and the second speed be about 50 RPM. The increase in speed may be linear or may be step-wise, for example, beginning at about 1 RPM and increasing by about 10 RPM increments evenly spaced over the tumble period. With regard to shrimp product, it has been shown that the optimal speed of rotation is about 30 RPM to about 35 RPM.

The tumble period is affected by raw product condition at the outset. If the raw product is initially hard frozen, a longer tumble period is required. Conversely, if the product is tempered, a shorter tumble period is required. The tumble period is ultimately determined by the seafood product, but ranges from about 20 minutes to about 60 minutes. With regard to shrimp, it has been shown that a tumble period of about 40 to 50 minutes is required if hard frozen, while about 20 minutes is required if initially tempered.

The invention may be embodied in other specific forms without departing from the essential characteristics thereof. The described embodiments are therefore to be considered in all respects as illustrative and not restrictive. Accordingly, the scope of the invention is established by the appended claims rather than by the foregoing description. All changes coming within the meaning and range of equivalency of the claims are therefore intended to be embraced therein. Further, the recitation of method steps above does not denote a limiting sequence for execution of the steps. Such method steps may therefore be performed in a sequence other than that recited unless the claim expressly states otherwise.

We claim:

1. A method for infusing flavors into delicate consumable proteins, the method steps comprising:
depositing a protein product into a tumbler device (110) drum (202) chamber, the chamber comprising an internal spiral baffle (304) having a product facing surface (502) forming an acute angle (504) with respect to the chamber inner surface (306);
adding a flavor profile brine to the chamber;
establishing a vacuum pressure within the chamber;
rotating the tumbler drum for a tumble period, beginning at a first speed and ending at a second speed;
releasing the vacuum pressure for removal of the protein product from the tumbler device for subsequent processing.

2. The method of claim 1, the method steps further comprising:
tempering the protein product before deposition.

3. The method of claim 1, the method steps further comprising:
maintaining a moisture content of the protein product between about 78% and about 85%.

4. The method of claim 1, the method steps further comprising:
orienting the drum (202) with the chamber opening (302) upward to establish an angle of about 30 degrees or less between the axis of rotation (212) and the surface upon which the tumbler device (110) is mounted.

5. The method of claim 1, the method steps further comprising:
cooling the rotating tumbler drum (202) to maintain the internal temperature below about 9° C.

6. The method of claim 1 wherein the acute angle (504) is an angle of between about 15 degrees and about 30 degrees.

7. The method of claim 1 wherein the first speed is about 1 RPM and the second speed is about 50 RPM.

8. The method of claim 1 wherein the first speed is about 30 RPM and the second speed is about 35 RPM.

9. The method of claim 1 wherein the first speed substantially equals the second speed.

10. The method of claim 1 wherein the first speed substantially equals the second speed at between about 30 RPM and about 35 RPM.

11. The method of claim 1 wherein the vacuum pressure is between about 25 inches of mercury and about 20 inches of mercury.

12. The method of claim 1 wherein the vacuum pressure is between about 29 inches of mercury and about 10 inches of mercury.

13. The method of claim 1 wherein the vacuum pressure is less than about 29 inches of mercury.

14. The method of claim 1 wherein the tumble period is between about 20 minutes to about 40 minutes.
